(19) United States
(12) Patent Application Publication
(10) Pub. No.: US 2007/0255958 A1
(43) Pub. Date: Nov. 1, 2007

(54) Claim transformations for trust relationships

(75) Inventors: Donald E. Schmidt, Redmond, WA (US); Danver W. Hartop, Sammamish, WA (US); Derek T. Del Conte, Sammamish, WA (US); Jagadeesh Kalki, Redmond, WA (US); Jeffrey F. Spelman, Woodinville, WA (US); Kahren Tevosyan, Kirkland, WA (US); Ryan D. Johnson, Bothell, WA (US); Vijayavani Nori, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/416,275

(22) Filed: May 1, 2006

(51) Int. Cl. H04L 9/00

(52) U.S. Cl. 713/183

(57) ABSTRACT

This disclosure relates to the ability to use multiple claim transformation modules in a trust relationship. Claim transformation modules transform a claim or claim set into a transformed claim or claim set for use by a trusted partner and/or application. Multiple claim transformation modules may be given the opportunity to act on a claim or claim set in a pipelined fashion. In another embodiment, multiple claim transformation modules may exist, but only the proper claim transformation module(s) is(are) given the opportunity to act on a claim or claim set. In an embodiment, the claims involved are security claims used for authentication purposes between trust partners in a federated authentication system.

### BACKGROUND

Separate organizations with distinct and separate computer systems often desire to provide information to each other, and, specifically, to each other's employees, customers, etc., in an efficient manner. To obtain information from an organization, a user typically is required to authenticate, or prove one's identity, by proving the possession of a credential, e.g., username and password, to the organization from which it requests information. However, instead of requiring separate security logon credentials, e.g., usernames and passwords, for access to information provided by the websites of separate organizations, the separate organizations may form business level agreements with each other to share and access information. A federated authentication system is an example of a system in which partners may share and access information by deploying their federation services. To share and access such information, a first partner may use identity data and/or authentication-related data to make “claims” to a second partner. In such a relationship, the second partner trusts the first partner to authenticate the user and to make certain claims about that user. However, it may be the case that the second partner is unable to understand the claims presented to it by the first partner. For example, the claims may not be in a format recognized by the second partner. The problem is exacerbated when organizations communicate with multiple partners.

Although specific problems have been addressed in this Background, this disclosure is not intended in any way to be limited to solving those specific problems.

### SUMMARY

Embodiments of the present invention generally relate to the transformation of claims or authentication information for sharing between trusted partners. Further embodiments relate to the use of multiple claim transformation modules in a federated system.

As discussed herein, an aspect of a particular embodiment relates to the use of multiple custom claim transformation modules as part of an extensibility point. In an embodiment, multiple claim transformation modules may be given the opportunity to act on a claim or claim set in a pipelined fashion to produce a transformed claim or claim set. In another embodiment, multiple claim transformation modules may exist, but only the proper claim transformation module(s) is(are) given the opportunity to act on the claim or claim set.

This summary is provided to introduce a selection of concepts in a simplified form that are further described below in the Detailed Description. This summary is not intended to identify key or essential features of the claimed subject matter, nor is it intended to be used in any way as to limit the scope of the claimed subject matter.

### BRIEF DESCRIPTION OF THE DRAWINGS

FIG. 1 illustrates a logical representation of a network environment for sharing “claim” information, comprised of identity data and/or authentication-related data, between two organizations, a first organization being an identity provider and a second organization being a resource provider in accordance with an embodiment of the present invention.

FIG. 2 depicts a general authentication environment showing the flow of claim data from one organization to another, e.g., from the identity provider to the resource provider shown in FIG. 1, having an extensible claim transformation module, in accordance with an embodiment of the present invention.

FIG. 3 shows a logical representation of a network environment showing multiple trust relationships in addition to the sample relationship shown in FIG. 1 and the use of multiple custom claim transformation modules in accordance with an embodiment of the present invention.

FIG. 4 depicts the multiple custom claim transformation modules of FIG. 4 as part of an extensibility point and arranged in a pipelined fashion in accordance with an embodiment of the present invention.

FIG. 5 is a flow diagram illustrating operational characteristics of a process for transforming claim information through the use of the multiple, pipelined, custom claim transformation submodules shown in FIG. 4 in accordance with an embodiment of the present invention.

FIG. 6 is a flow diagram illustrating operational characteristics of a process involving the multiple custom claim transformation submodules of FIG. 3 and mapping of a claim to a proper custom claim transformation submodule in accordance with another embodiment of the present invention.

FIG. 7 is another embodiment associated with FIG. 5 for aggregating isolated resultant claims.

FIG. 8 is an additional embodiment associated with FIG. 6 for aggregating isolated resultant claims.

FIG. 9 is a flow diagram illustrating the operational characteristics of a process involving the creation, plugging-in, and configuring of the custom claim transformation submodules of FIG. 3.

FIG. 10 depicts an exemplary computing system upon which embodiments of the present disclosure may be implemented.

### DETAILED DESCRIPTION

This disclosure will now more fully describe some exemplary embodiments with reference to the accompanying drawings, in which some embodiments are shown. Other aspects may, however, be embodied in many different forms and the inclusion of specific embodiments in this disclosure should not be construed as limiting such aspects to the embodiments set forth herein. Rather, the embodiments depicted in the drawings are included to provide a disclosure that is thorough and complete and which fully conveys the intended scope to those skilled in the art. When referring to the figures, like structures and elements shown throughout are indicated with like reference numerals.

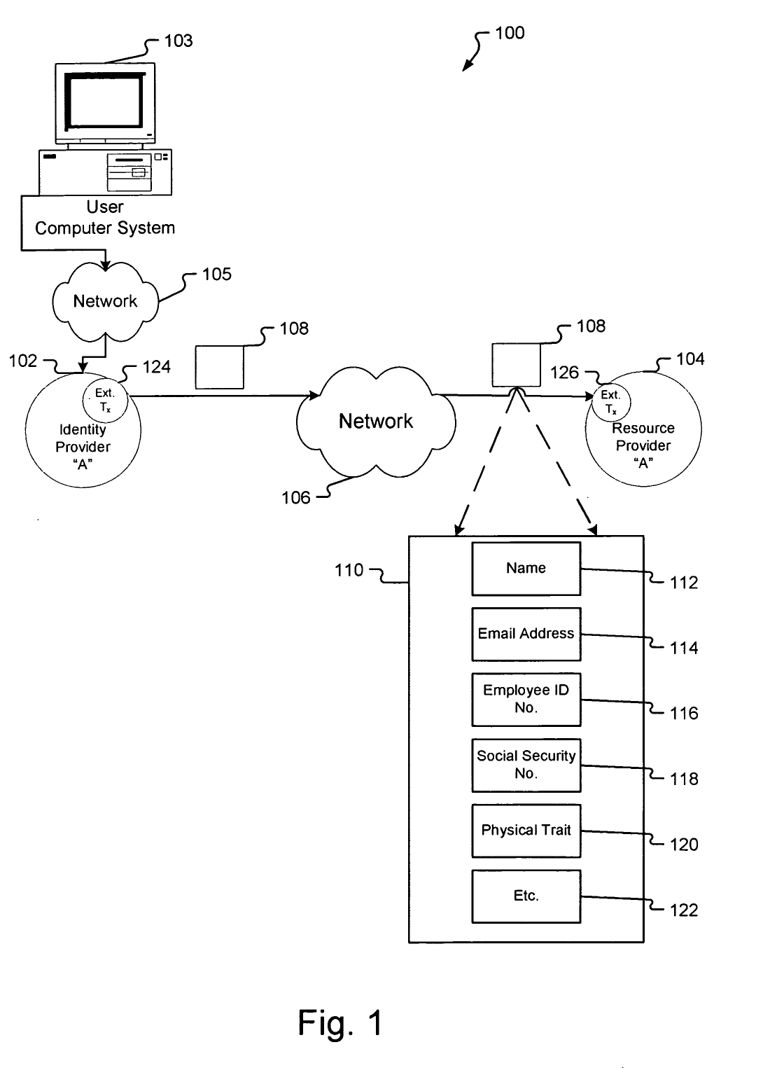

An environment 100 illustrating a first organization 102, also referred to as identity provider 102, sharing a security token 108, which token is cryptographically signed by identity provider 102 and contains a claim or claims, with a second organization 104, also referred to as resource provider 104, is shown in FIG. 1. While an embodiment of the present invention refers to “claims,” a single claim could be contained in the security token 108 in accordance with another embodiment of the present invention. In this exemplary environment, user 103 authenticates using some credential transmitted over network 105 to identity provider 102. The user requests a security token 108 which can be used to authenticate to resource provider 104. Leveraging the original authentication event, identity provider 102 forms a security token 108 which contains various claims about the user. The user 103 presents the security token 108 to the resource provider 104 and, after the resource provider 104 verifies that the security token was issued by a trusted party and that the party was authorized to make the claims therein, the resource provider 104 grants access to resources based on those claims.

In an embodiment, a cryptographically signed security token constitutes cryptographic proof that the identity provider 102, or “claimant,” is trusted by the resource provider 104. Thus, resource provider 104 trusts identity provider 102 to authenticate the user 103 and to make certain claims about that user. This relationship is referred to as a “trust relationship” because the resource provider 104 “trusts” the identity provider 102. The trust relationship of the resource provider 104 and the identity provider 102 is thus defined as the logical relationship between the resource provider 104 domain and the identity provider 102 domain, in which the resource provider 104 honors the claims of the identity provider 102 about its user(s) 103. While the term “trust relationship” is used, this relationship is not bilateral in any way. Instead, the resource provider 104 trusts the identity provider 102, and identity provider 102 and resource provider 104 may be referred to as trust partners.

In the exemplary embodiment of FIG. 1, organizations 102 and 104 thus have a trust relationship such that security token 108, which can be used to authenticate to resource provider 104, is transmitted over network 106 to organization 104. The security token 108 authenticates the user 103 to resource provider 104 where the security token 108 is issued by a trusted party, i.e., identity provider 102 in accordance with the exemplary embodiment shown in FIG. 1. The claims included in security token 108 are used after authentication to customize the experience of user 103 and/or make authorization decisions. The trust relationship thus allows for the different flow of information between identity provider 102 and resource provider 104. While the flow of information may exist, the claims transmitted in security token 108 have, in an embodiment, been transformed from one format to another format prior to sharing. This transforming of the claim information in security token 108 may be accomplished through the use of a claim transformation module inserted as part of an extensibility point 124 in identity provider 102's domain. While a single claim transformation module may be used, multiple claim transformation modules may be plugged in as part of the extensibility point. In another embodiment, the claim information may be transformed after it is transmitted over network 106 through the use of extensible claim transformation module 126. Aspects of this embodiment also allow for the use of multiple claim transformation modules.

FIG. 1 shows the flow of claim information 108 from the identity provider 102 to the resource provider 104. In accordance with an embodiment of the invention, claim information in security token 108 is actually a set of specific claims, shown as claim set 110. Each claim generally relates to identification information related to a particular person or user, e.g., a claim may include the user's name 112, and another claim may include the user's email address 114. Other claims may relate to the user's employee identification number 116, Social Security Number 118, physical trait 120, e.g., hair color, etc. 122. The claim information contained in security token 108 is used to customize the user experience and/or make authorization decisions. That said, the formatting (or content) of the claims may be modified depending on the resource provider, as discussed below. In an embodiment, the claims are used by resource provider 104 to verify, or authenticate, accounts for users of identity provider 102. While an embodiment may have multiple claims included in the security token 108 depicted in FIG. 1, another embodiment may involve a flow consisting of a single claim.

As noted, in embodiments of this invention, identity provider 102 and resource provider 104 are trust partners. Identity provider 102 and resource provider 104 may be any type of entity, such as, by way of example only, companies, enterprises, individuals, etc. As will be appreciated, any computer system may act as such an entity. As may also be appreciated, trust relationships between such entities are known to those skilled in the art. In general, the trust relationship requires security authentications to authenticate a user before permitting access to the organization's resources. The Web Services (WS) - Federation is a mechanism which enables the sharing of identity information across organization boundaries, wherein each trust partner deploys its federated services to enable such sharing and accessing of information. Thus, such a trust relationship may also be referred to as a “federated” authentication relationship, and a claim may be referred to as being “federated” across a network from identity provider 102 to resource provider 104. To enable such sharing, WS-Federation generally uses Extensible Markup Language (XML) security tokens, in which such security tokens utilize formats such as Security Assertion Markup Language (SAML) or Extensible Rights Markup Language (XrML). These security tokens include, but are not limited to, claim information. The WS-Federation is a specification which describes a communication protocol. The WS-Federation protocol is implemented by Active Directory Federated Services (“ADFS”), which is produced by Microsoft Corporation.

In an embodiment of the invention, identity provider 102 has an extensible claim transformation module 124 to accomplish a transformation of claim information from one format to that specified by resource provider 104. Transformation module 124 acts to transform the claim or claim set into the desired format. Similarly, in another embodiment, a resource provider may deploy multiple and different applications, in which such applications may not accept all security claims in the same format. By way of example only, one application of a resource provider may require the user's date of birth while another application may require the user's age in years. It may thus be necessary for the resource provider to transform the format of the claim provided by the identity provider to that required by the particular resource application. Thus, in one embodiment, an extensible resource provider claim transformation module 126 is used in situations including, although not limited to, those such as where the identity provider 102 does not provide the claim in the proper format recognized or required by the resource provider 104 or where further or a different transformation of a claim is required for a particular resource application. In embodiments, the identity provider and resource provider claim transformation modules are thus customized for the particular identity provider 102 and particular resource provider 104 in the trust relationship (or, analogously, for a particular resource application) and may also be referred to as “custom” claim transformation modules.

As noted, identity provider 102 and resource provider 104 share and access information across a network 106. The networks 105 and 106 may be any type of networks conventionally known to those skilled in the art. In accordance with an exemplary embodiment, the network may be the global network (e.g., the Internet or World Wide Web). It may also be a local area network or a wide area network. In another embodiment, the network may be a private network, e.g., an intranet, although the organizations have entirely separate and distinct domains of management. While the network 106 may be any type of network conventionally known to those skilled in the art, the network 106 is described in accordance with an exemplary embodiment as the “World Wide Web” (i.e., “Web” for short). As such, communications over the network 106 occur according to one or more standard packet-based formats (e.g., H.323, IP, Ethernet, ATM).

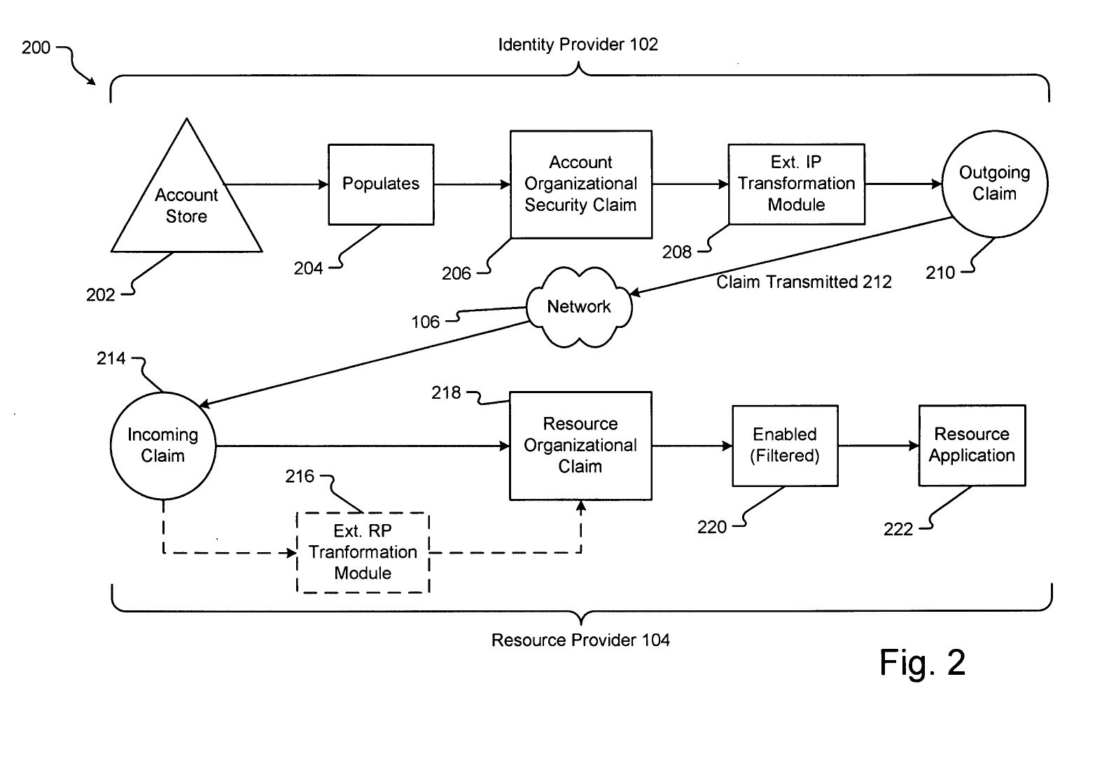

Turning now to a more detailed illustration of a federated authentication system in accordance with an embodiment of the invention, FIG. 2 illustrates the flow of claim data across the network 106 between an identity provider 102 and a resource provider 104. The general flow 200 begins on the identity provider 102 side at the account store 202, in which the account store 202 provides identity information which is used by the identity provider 102 to make claims. In this embodiment, account store 202 is a component that manages data for authenticating accounts (e.g., users) associated with identity provider 102. By way of example only, account store 202 may include Active Directory (AD), Active Directory Application Mode (ADAM), Structured Query Language (SQL) systems, or similar such systems.

The account store 202 populates 204 the account organizational claim (“claim”) 206 with security information. The claim 206 is then transformed in the extensible identity provider transformation module 208 from the account store specific format to a federated format recognized by the resource provider 104. The transformed claim leaves the transformation module 208 as outgoing claim 210, which is packaged into a security token, such as security token 108, and is transmitted 212 over the network 106 to resource provider 104. The outgoing claim 210 enters the resource provider 104 side as incoming claim 214. While the terms “outgoing claim” 210 and “incoming claim” 214 are used, it is to be understood that such claims are included in, or packaged into, a security token, such as security token 108. Before any further processing on the resource provider side 104, the cryptographic signature of the security token 108 is verified to ensure that the issuer, i.e., the identity provider 102 in the exemplary embodiment of FIG. 1, is trusted to make the claims in the security token 108. Once this verification is made, processing continues on the resource provider side 104. While the format of the claims in security token 108 may already have been transformed to a format recognizable by resource provider 104, in an embodiment where such transformation has not occurred or where further transformation is required, the extensible resource provider transformation module 216 may transform, or further transform, incoming claim 214 from the federated format to a format recognized by resource application 222 as resource organizational claim (“claim”) 218. Because this step may be considered optional, resource provider custom claim transformation module 216 is shown in dashed-lines format in FIG. 2. In an embodiment, identity provider custom claim transformation module 208 may also be considered optional. In another embodiment, only resource provider custom claim transformation module 216 or, alternatively, only identity provider custom claim transformation module 208 may be considered optional. The claim is then enabled 220 for use by resource application 222. The enabling 220 step may involve filtering of claim data so that not all claim data are sent to resource application 222. It should be noted that although identity provider and resource provider transformation modules 208 and 216 are shown as single blocks in federated authentication system 200, these transformation modules, as discussed, may be extensibility points for the use of multiple claim transformation modules or submodules.

The flow of claim data in FIG. 2 is between a specific identity provider 102 and a specific resource provider 104. For example, on the identity provider 102 side, the identity provider transformation module 208 transforms the incoming account organization claim 206 from an account store 202 specific format to a federated format recognized by resource provider 104. An intermediate step or steps may be involved in this transformation. Exemplary embodiments of such are described in U.S. patent application No. ______(MS 312161.01), entitled “Security Claim Transformation with Intermediate Claims,” assigned to common assignee Microsoft Corporation, the entire disclosure of which is incorporated herein. The resultant claim information may be transformed through the use of multiple custom claim transformation modules or submodules in accordance with embodiments of the present invention.

According to some embodiments, a given identity provider may federate and send claim information to several different resource providers. Referring back to FIG. 2, although an extensible claim transformation module is depicted in this figure, e.g., identity provider claim transformation module 208, an embodiment of the present invention may involve the use of a single custom claim transformation module inserted as part of the extensibility point on the identity provider “A” 102 side, which transformation module is customized to transform the claim into the format recognized by the predetermined resource provider “A” 104 with which the identity provider is in a trust relationship. However, when a new trust relationship is created by the identity provider “A” 102 with a different resource provider “B,” the identity provider custom claim transformation module would have to be changed to customize the transformation of claims to the federated format recognized by the new resource provider “B” and subsequently for each new resource provider “n.”

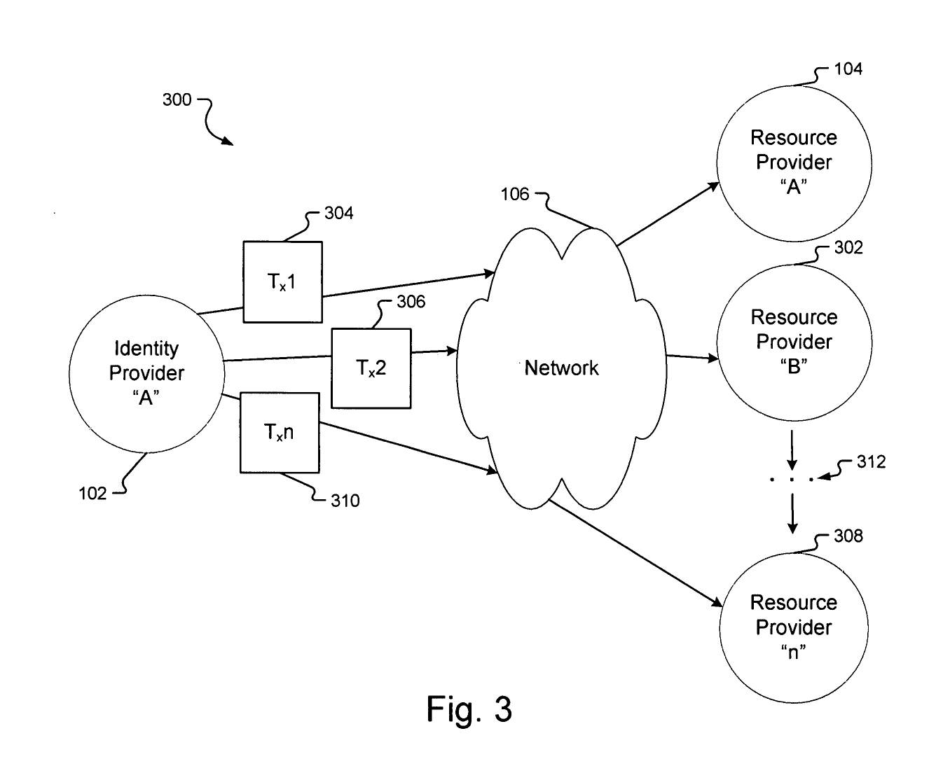

Multiple trust relationships and custom claim transformation modules are thus possible and are shown in the logical representation of the network environment 300 in FIG. 3. Identity provider “A” 102 has a trust relationship with resource provider “A” 104, and the claim is transformed by the custom claim transformation module Tₓ1 304. A new trust relationship is then created between identity provider “A” 102 and a different resource provider “B” 302 and the claim transformation module is rewritten to be customized as Tₓ2 306 to this new pair. Such relationships and custom claim transformation modules may exist up to an indeterminate number of resource providers “n” 308, as indicated by ellipses 312, and corresponding custom claim transformation modules Tₓn 310. Similarly, and analogously, multiple transformations may be required on the resource provider side 104 of a typical federated authentication system where an incoming claim has a specific federated format which is transformed for a possible multitude of predetermined separate and distinct resource applications 222.

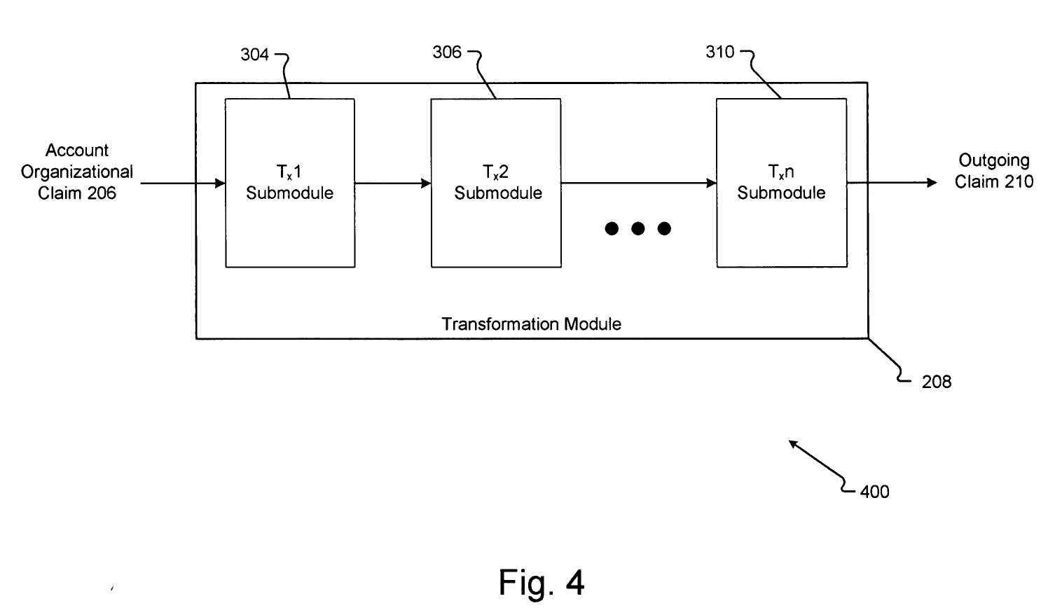

However, instead of having a single custom claim transformation module for each pair of identity and resource providers and having to change that single module upon the creation of each new trust relationship with a new resource provider, embodiments of the present invention have multiple custom claim transformation submodules plugged into the extensibility points of the transformation modules 208 and/or 216 of the federated authentication system. While the term “submodules” is used herein, these “submodules” are technically independent entities, which can be used alone or in combination in accordance with embodiments of the present invention. Thus, the term “module” could be used to describe these independent entities. However, the term “submodules” is used herein for simplicity purposes to refer to those modules which comprise the overall extensible transformation module 208 and/or 216. Turning to FIG. 4, a transformation module embodiment 400 is illustrated in which such submodules may be plugged into the federated authentication system at the transformation module 208 and/or 216 extensibility, or extension, points in a connected (or pipelined) fashion. These pipelined transformation submodules could then be invoked in a pipelined fashion so that each transformation submodule could work on the claim set, where applicable, and build the resultant claim set for transmittal to the resource provider trust partner. These multiple custom claim transformation submodules may be called in pipelined fashion working off of one claim set. As noted, embodiments of the present invention may involve a single claim, while other embodiments may involve a claim set. As shown in FIG. 4, incoming account organizational claim 206 (or incoming claim 214 in another embodiment) is processed first by transformation submodule 1 (“Tₓ1”) 304 and is then processed by Tₓ2 306, etc., in pipelined fashion for “n” different transformation modules Tₓn 310 to outgoing claim 210 (or to enabling 220 in another embodiment). Each transformation submodule is called in pipelined fashion; however, only those submodules written for the specific transformation required will actually act upon, i.e., transform, the claim or claim set.

Referring to the exemplary embodiment depicted in FIG. 4, if Tₓ1 304 is written to transform the claim from identity provider 102 to a format recognized by resource provider 104, then it will act upon the claim only if the incoming claim is from identity provider 102 and the outgoing claim 210 is to go to resource provider 104. If identity provider 102 and resource provider 302 are involved, but Tₓ1 304 is written to transform claims from identity provider 102 to resource provider 104, for example, then Tₓ1 304 will not act upon the claim, and the claim will pass to Tₓ2 306 (as shown in FIG. 4). Similarly, and analogously, Tₓ1 304 may be written to transform an incoming claim 214 with a specific federated format to a specific resource application 222, while Tₓ2 306 may be written to effect such a transformation for a different and separate resource application.

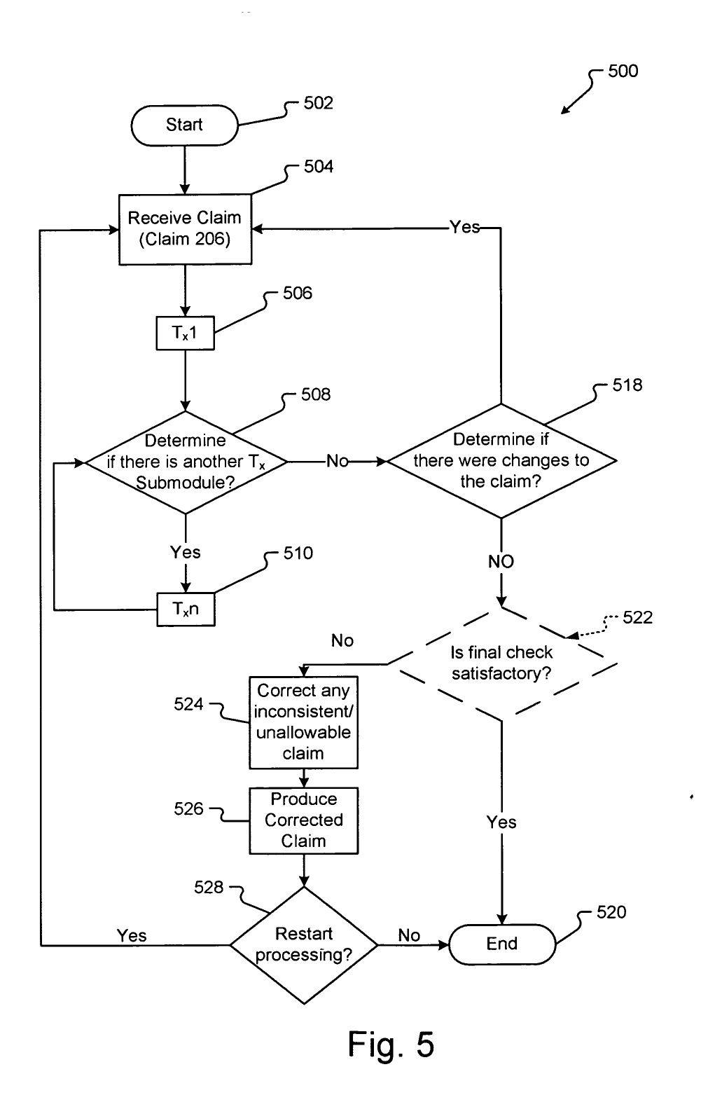

With respect to FIG. 5, a process 500 for transforming a claim or a claim set through the use of multiple custom claim transformation submodules organized in a pipelined fashion is shown in accordance with an embodiment of the present disclosure. Where, in accordance with an embodiment of the invention, a claim set is transformed, the transforms apply to all claims within the claim set, and not to individual claims. Thus, in an embodiment, changes could be made based on the values of several claims, or, alternatively, one claim could result in several new claims. While the transformation modules 208 and 216 in a general sense allow for a certain amount of manipulation of a claim, the use of multiple custom claim transformation modules, or submodules, organized in a pipelined fashion allows for the modularization of these manipulations of a claim. The transformation process 500 is performed using an operation flow that begins with start operation 502.

Start operation 502 is initiated following the populating of the account organizational claim 206 (or incoming claim 214 in another embodiment). From the start operation 502, the operation flow of process 500 proceeds to a receive operation 504. Receive operation 504 receives an incoming account organizational claim 206 (or incoming claim 214 in another embodiment). From the receive operation 504, the operation flow passes to a custom claim transformation operation Tₓ1 506. The Tₓ1 transformation operation transforms the claim if applicable. The operation then passes to query operation 508. The query operation 508 determines whether another custom claim transformation submodule, and resulting transformation operation, exists. If query operation 508 determines that another custom claim transformation exists, flow branches YES to custom claim transformation submodule Tₓn 510 for an indeterminate number of custom claim transformation submodules and query operations. If another custom claim transformation submodule is not detected at query operation 508, flow branches NO to query operation 518 which determines whether any changes were made. If a change is detected, flow branches YES back to receive operation 504 for repeated processing through the custom claim transformation submodules pipeline. The re-processing of the claims based on changes acts as a security feature so as not to allow one transformation submodule to make a change inconsistent with that of another custom claim transformation.

On the other hand, if query operation 518 does not detect changes to the claim, steady-state is achieved and the operation flow of the transformation process 500 branches NO to terminate operation 520. The terminate operation 520 ends the transformation process. As an additional security feature, it is also possible to pass the operation flow through transformation check query operation 522 to confirm that no inconsistent, or otherwise unallowable, changes have been made by any custom claim transformation submodule(s). This final check step is optional and is thus shown in dashed-lines format in FIG. 5 as query operation 522. If query operation 522 determines that the final check is not satisfactory, i.e., that unallowable changes exist, flow branches NO to correct operation 524. Correct operation 524 corrects any inconsistent or unallowable claims. From correct operation 524, process 500 proceeds to produce operation 526, which produces the corrected claim (or claim set). Following the producing of the corrected claim or claim set, flow proceeds to restart query 528, which determines whether processing should be restarted to allow the changes made to be reprocessed. If restart query 528 determines that reprocessing should be performed, flow branches YES to receive operation 504. If restart query 528 determines that no reprocessing should be performed, flow branches NO to terminate operation 520. Similarly, if query operation 522 determines that the final check is satisfactory, i.e., that changes are allowable and/or consistent, flow branches YES to terminate operation 520. Terminate operation 520 ends transformation process 500. From there, the outgoing claim is transmitted via the network 106 to the resource provider 104. Alternatively, but analogously, a claim transformed by the resource provider transformation module 216 is enabled 220 for a resource application 222. In enabling 220 the claim, the claim data may be filtered if desired.

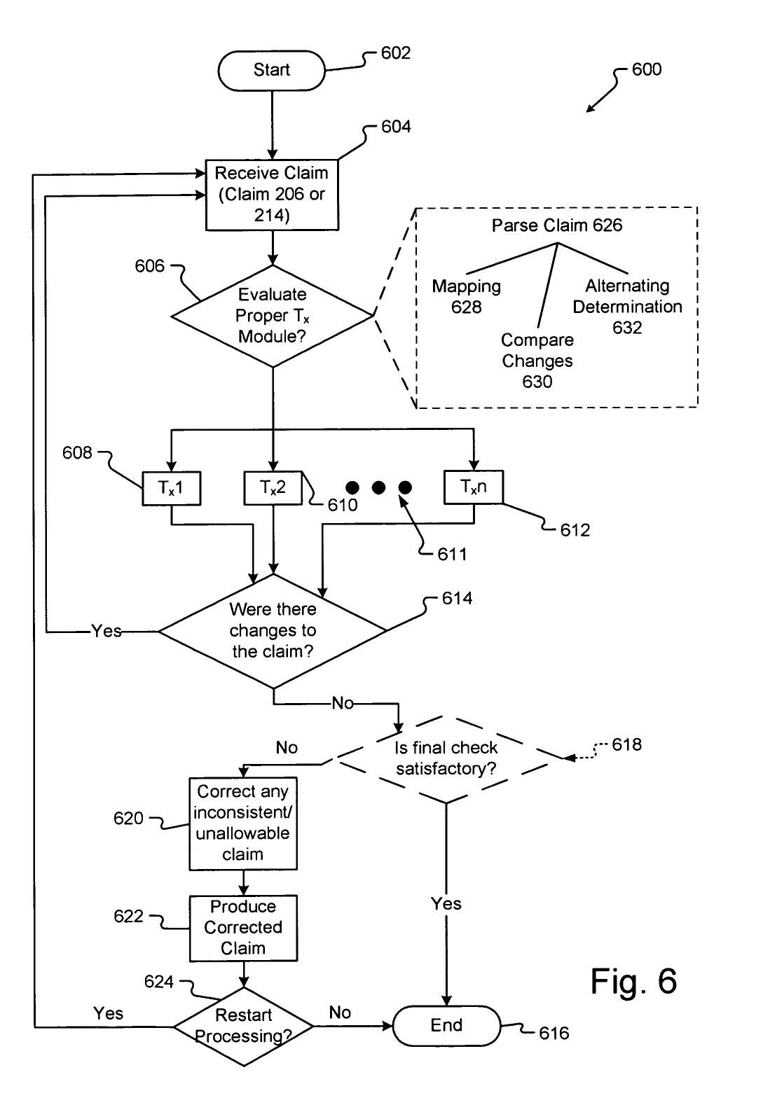

Turning now to FIG. 6, mapping process 600 involving multiple custom claim transformation modules or submodules is shown in accordance with an embodiment of the present disclosure. Mapping process 600 refers to an embodiment where only the proper custom claim transformation submodule(s) is(are) given the opportunity to act on a security claim or claim set. For example, in the case of transformations on the identity provider side 102 of a federated authorization system described with respect to an embodiment of this invention, “proper” could refer to those custom claim transformation submodules written for the particular identity provider and paired resource provider involved in the trust relationship. Similarly, and analogously, in another embodiment involving transformations on the resource provider side 104 of a typical federated authorization system, “proper” could refer, for example, to those transformations written for a specific federated claim format and a predetermined resource application or service 222.

Transformation mapping process 600 is described in accordance with an exemplary embodiment as being performed using an operation flow that begins with start operation 602 initiated following the populating of account organizational claim 206 (or the receipt of incoming claim 214 in another embodiment). As discussed above, an embodiment may involve a single claim, while another embodiment may involve a claim set. Where a claim set is transformed, the transforms apply to all claims within the claim set. From start operation 602, the operation flow of process 600 proceeds to receive operation 604. Receive operation 604 receives the account organizational claim 206 (or incoming claim 214 in another embodiment). From receive operation 604, the operation flow passes to evaluate operation 606. Evaluate operation 606 determines the proper custom claim transformation submodule, i.e., Tₓ1 608, Tₓ2 610, . . . Tₓn 612, to which to send the claim for transformation. In accordance with an embodiment of the invention, one or multiple claim transformation submodules, as indicated by ellipses 611, may be used. To determine which custom claim transformation submodule is proper, evaluate operation 606 parses 626 the claim, looks at mapping choices 628, compares changes 630, if any (in which changes may already have been made in an embodiment where the claim received at receive operation 604 has already been transformed), etc. In addition, in an embodiment where more than one transformation submodule is “proper,” evaluate operation 606 will ensure that each such proper claim transformation submodule is given the opportunity to work on the claim. For example, in one embodiment, evaluate operation 606 determines the proper custom claim transformation submodules, and, where more than one such module is deemed to be proper, evaluate operation 606 sends the claim in alternating fashion 632 to the proper custom claim transformation submodules so that a false appearance of steady-state change will not occur as it would if the claim were repeatedly sent to the same custom claim transformation submodule.

Upon determining the proper transformation submodule to which to send the claim, the claim is sent to Tₓ1 608, Tₓ2 610 . . . Tₓn 612. Following the custom claim transformation Tₓ1 608, Tₓ2 610 . . . Tₓn 612, the operation proceeds to query operation 614. Query operation 614 determines whether any changes have been made to the claim. If query operation determines a change to the claim exists, flow branches YES to receive operation 604 and then flows to evaluate operation 606 where the claim is again parsed 626, mapping is evaluated 628, changes are compared 630, alternating “proper” transformation submodule patterns, if any, are detected 632, etc.

This operation flow repeats until query operation 614 determines that no changes to the claim exist and steady-state is achieved. If query operation 614 determines that no changes exist, flow branches NO to terminate operation 616. As an additional security feature, it is also possible to pass the operation flow through transformation check query operation 618 to confirm that no inconsistent, or otherwise unallowable, changes have been made by the custom claim transformation submodule(s). This final check step is optional and is thus shown in dashed-lines format in FIG. 6 as query operation 618. If query operation 618 determines that the final check is not satisfactory, i.e., that unallowable change(s) exist, flow branches NO to correct operation 620. Correct operation 620 corrects any inconsistent or unallowable changes. From correct operation 620, process 600 proceeds to produce operation 622, which produces the corrected claim (or claim set in an embodiment). Following the producing of the corrected claim, flow proceeds to restart query 624, which determines whether processing should be restarted to allow the changes made to be reprocessed. If restart query 624 determines that reprocessing should be performed, flow branches YES to receive operation 604. If restart query 624 determines that no reprocessing should be performed, flow branches NO to terminate operation 616. Similarly, if query operation 618 determines that the final check is satisfactory, i.e., that changes are allowable, flow branches YES to terminate operation 616. Terminate operation 616 ends transformation process 600. From there, the outgoing claim is transmitted via the network 106 to the resource provider 104. Alternatively, but analogously, a claim transformed by the resource provider transformation module 216 is enabled 220 for a resource application 222. In enabling 220 the claim, the claim data may be filtered if desired.

It should be appreciated that the processes shown in FIGS. 5 and FIG. 6, and described accordingly herein, may apply to the transformation of a claim on either the identity provider 102 side or the resource provider 104 side of a typical federated authorization system. For example, mapping to the proper claim transformation submodule on the identity provider side would involve determining the identity of the identity provider 102 and the resource provider 104. Analogously, mapping to the proper resource provider claim transformation submodule would involve a similar determination process but would involve a determination as to the format of the federated incoming claim and the format required by the specific resource application or services for which the claim is intended. Thus, receive operation 604 may apply to account organizational security claim 206 or incoming claim 214 in accordance with embodiments of this invention.

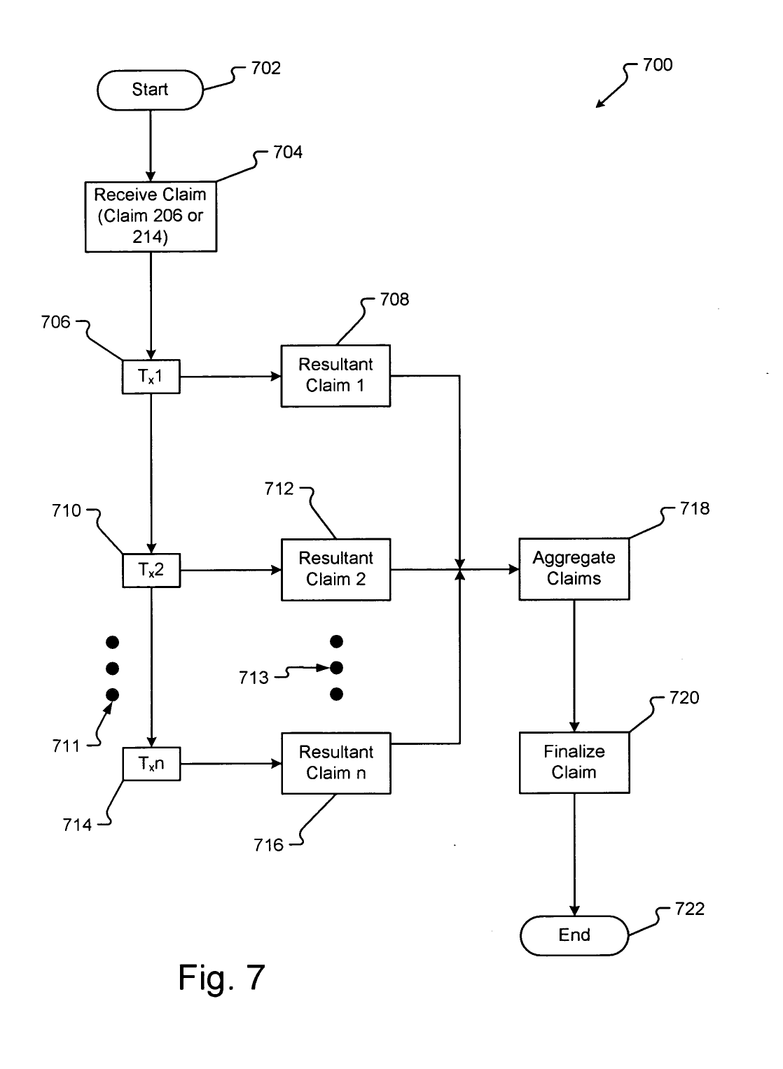

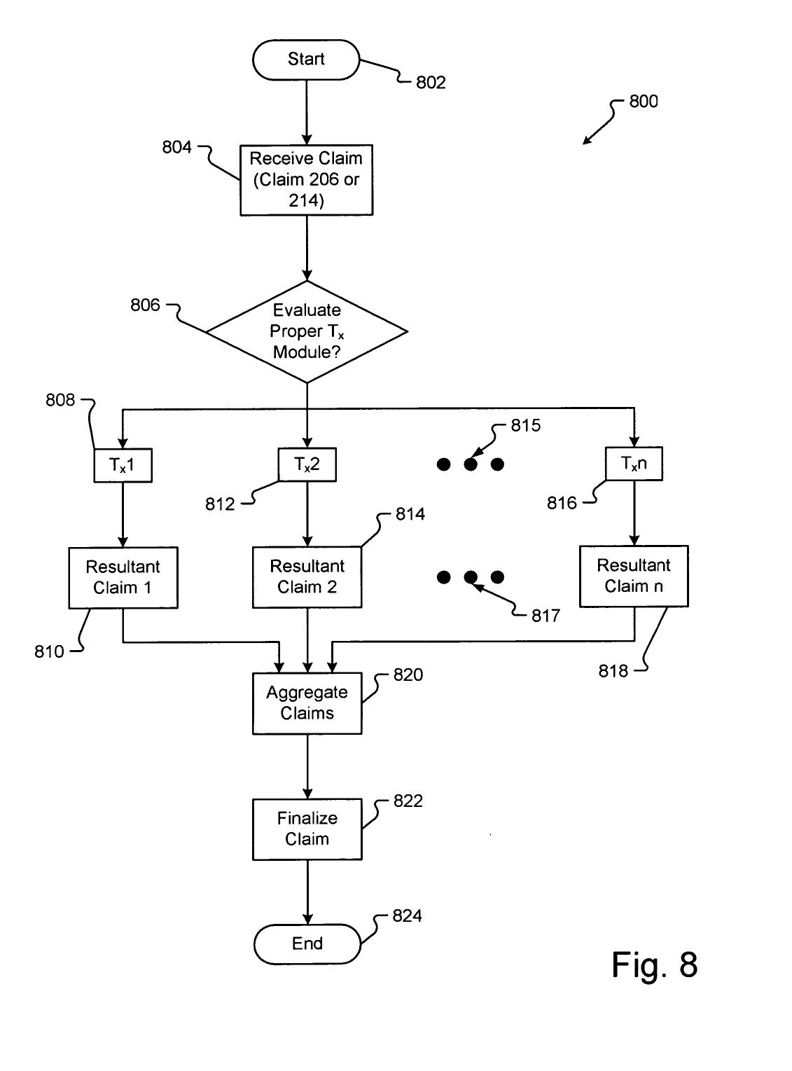

Turning now to FIGS. 7 and 8, process 700 and process 800 are shown in accordance with exemplary embodiments of the present disclosure wherein the resultant claim or claim set from each of the custom claim transformation submodules is isolated so that each transformation submodule acts only on the original claim or claim set. Processes 700 and 800 then maintain and aggregate the resultant claims. Start operation 702 is initiated in response to the populating of an account organizational claim 206 (or the transmittal of an incoming claim 214 in another embodiment involving the resource provider side 104). From start operation 702, the operation flow of process 700 proceeds to receive operation 704. Receive operation 704 receives the account organizational claim 206 (or incoming claim 214 in another embodiment). From receive operation 704, the flow passes to custom transform operation Tₓ1 706, which transforms the claim, if applicable, to resultant claim 1 708. An unchanged form of the original claim then passes to Tₓ2 710, which transforms the claim, if applicable, to resultant claim 2 712. In accordance with embodiments of the invention, and as indicated by ellipses 711 and 713, a single transformation module 706 or “n” transformation modules 714 and a single resultant claim 708 or “n” resultant claims 716 may be used. The original claim passes in pipelined fashion to Tₓn submodules 714 and resultant “n” claims 716. The resultant claims 708, 712 and 716 are maintained, and the flow then proceeds to aggregate operation 718 which aggregates the resultant claims to produce a final claim or claim set 720. Terminate operation 722 ends the process.

Similarly, process 800 begins with start operation 802, which is initiated in the same manner as that described with respect to start operation 702 above. The operation flow then proceeds to receive operation 804, also in the same manner as that described for receive operation 704 above. From receive operation 804, the operation flow passes to evaluate operation 806 which determines the proper transformation submodule (as described and depicted in FIG. 6 above) to which to send the original claim. In accordance with embodiments of the invention, and as indicated by ellipses 815 and 817, a single transformation submodule 808 or “n” transformation submodules 816 and a single resultant claim 810 or “n” resultant claims 818 may be used. The transformation submodules Tₓ1 808, Tₓ2 812 . . . Tₓn 816 may then work on the original claim or claim set in isolation to produce resultant claims 810, 814 and 818, respectively. The operation then proceeds to aggregate operation 820 which aggregates the resultant claims to produce a final claim or claim set 822. Terminate operation 824 ends the process. As described with respect to FIG. 7 and process 700, another embodiment related to FIG. 8 may involve incoming claim 214 to receive operation 804, wherein incoming claim 214 exists on the resource provider 104 side depicted in FIG. 2.

It should be appreciated that other embodiments of the present invention may provide for additional steps to be added to processes 700 and 800 so as to allow, for example, for checks regarding changes to the claims, etc., to achieve steady-state operations. Processes 700 and 800 are illustrated in a generalized form so as to show the concept of isolating the resultant claim or claim set from each custom claim transformation submodule. As with the other figures, the generalized form of FIGS. 7 and 8 should not be interpreted in any way as being limited to the particular steps depicted or described herein.

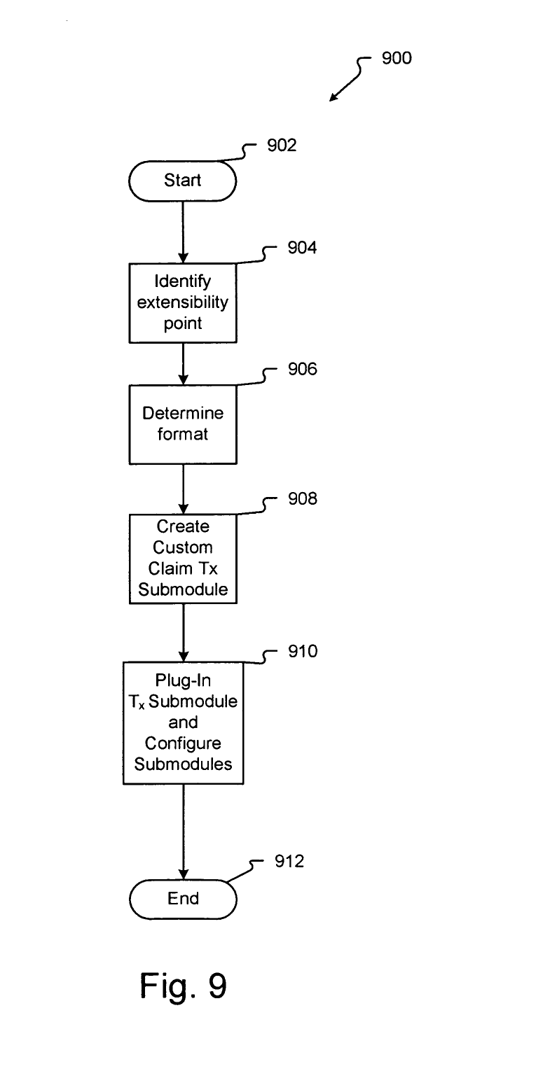

According to aspects of an embodiment illustrated in FIG. 9, organizations may customize their claim requirements and transformation capabilities, as discussed above in reference to FIGS. I and 3. The flow operations related to such are shown in FIG. 9. Process 900 begins with start operation 902, which is initiated in response to the creation of a trust environment with an extensible authentication system, such as that depicted as particular embodiments in FIGS. 1 and 2. The flow then proceeds to identify operation 904 which identifies the existence of extensibility point(s) 124, 126, 208, and/or 216. From identify operation 904, the flow proceeds to determine format operation 906, which, in one embodiment, determines the claim format of the identity provider 102 and the required or preferred claim format of the resource provider 104. In another embodiment involving the resource provider side 104 of the flow of claim data shown in FIG. 2, determine format operation 906 determines the claim format of the incoming claim 214 and the format required for a predetermined resource application 222. Following determine format operation 906, the flow proceeds to create custom claim transformation submodule operation 908. According to one embodiment, create operation 908 creates a custom claim transformation submodule, e.g., 304, 306, or 310, to change the claim format from that of the identity provider 102 to that required or preferred by the resource provider 104. In another embodiment, operation 908 creates a custom claim transformation submodule, e.g., 304, to change the claim format from that of the incoming claim 214 to the format required for a predetermined resource application or service 222.

From create operation 908, the flow proceeds to plug-in and configure operation 910, in which the custom claim transformation submodule created in create operation 908 is plugged in as part of the extensibility point identified in identify operation 904. In one embodiment, the custom claim transformation submodule 304 may be plugged in with other custom claim transformation submodules configured in pipelined fashion as part of the extensible transformation module 124, 126, 208, and/or 216. In another embodiment, custom claim transformation submodule 304 may be plugged in as part of an extensible transformation, e.g., 124, which is configured to send the claim for transforming only to those submodules determined to be proper for such processing, as illustrated and discussed above with reference to FIG. 6. Other embodiments may involve additional and/or different configurations, and the types described herein are intended in no way to be construed as limiting. Further, reference to transformation 304 or 124 is for exemplary purposes only. Any transformation module or submodule may be used. Terminate operation 912 ends process 900.

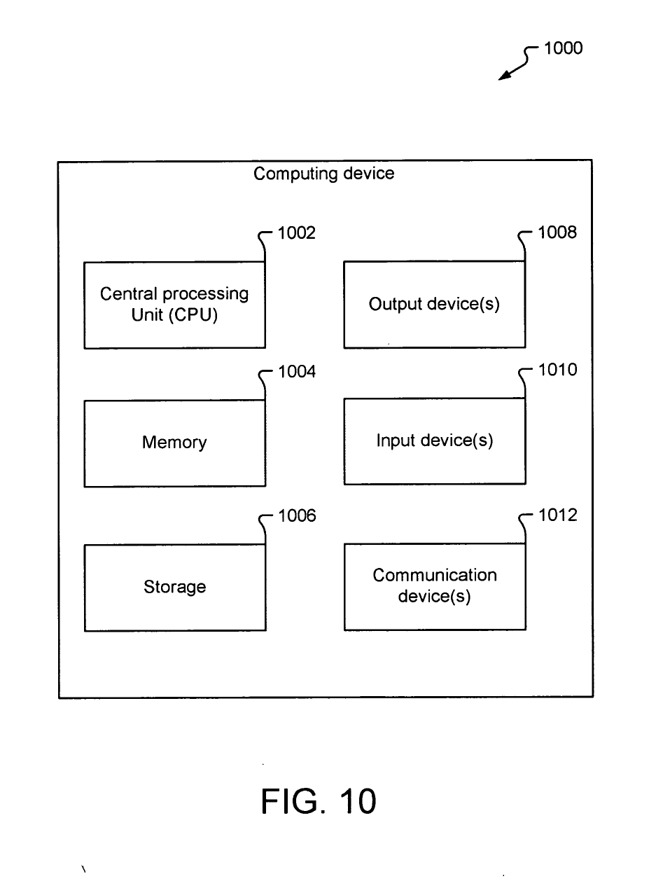

An exemplary computing environment for implementing the systems and methods described and illustrated herein is shown in FIG. 10. In its most basic configuration, computing system 1000 typically includes at least one central processing unit (CPU) 1002 and memory 1004 such as to store claim information in security token 108 as with account store 202 in one embodiment. Depending on the exact configuration and type of computing device, memory 1004 may be volatile (such as RAM), non-volatile (such as ROM, flash memory, etc.) or some combination of the two. Additionally, computing device 1000 may also have additional features/functionality. For example, computing device 1000 may include multiple CPUs. The described methods may be executed in any manner by any processing unit in computing device 1000. For example, the described process may be executed by multiple CPUs in parallel.

Computing device 1000 may also include additional storage 1006 (removable and/or non-removable) including, but not limited to, magnetic or optical disks or tape for storing claim information in security token 108 as with account store 202 according to one embodiment. Computer storage media includes volatile and nonvolatile, removable and non-removable media implemented in any method or technology for storage of information such as computer readable instructions, data structures, program modules or other data. Memory 1004 and storage 1006 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 1000. Any such computer storage media may be part of computing device 1000.

Computing device 1000 may also contain communications device(s) 1012 that allow the device to communicate with other devices such as to transmit claim information in security token 108 between trust partners 102 and 104 according to one embodiment of the present invention. Communications device(s) 1012 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network (such as networks 105 or 106 shown in accordance with one embodiment) or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device 1000 may also have input device(s) 1010 such as keyboard, mouse, pen, voice input device, touch input device, etc. In addition, output device(s) 1008 such as a display, speakers, printer, etc. may also be included. All these devices are well known in the art and need not be discussed at length. While specific examples have been given with regard to the components of computing device 1000, these examples are not intended to be limiting in any way.

In considering the disclosure provided above, it should be readily apparent to one skilled in the art that the present invention affords numerous benefits. For example, it is beneficial for aggregate functionality purposes to be able to call the multiple transformation submodules discussed with reference to FIGS. 4, 5 and 6, for example, for a single authorization of a claim or claim set. The present invention is also advantageous in its ability to partition claim transformation code, as depicted in FIGS. 4, 5 and 6, for example, into multiple modules or submodules and, thus, to achieve integration with disparate versions of core run-time libraries. Because the invention allows for multiple custom claim transformation modules or submodules to be plugged in at the extensibility points of transformation modules 208 and/or 216, the invention allows third-party claim transformation modules or submodules to be plugged into the system. Further, the invention allows for the introduction of constructs to determine steady-state for forward-chaining transformations as depicted in FIGS. 5 and 6, for example, and as described above.

In addition, the invention is beneficial in its provision of multiple security features. For example, enhanced security is achieved through the invention's ability to finalize claims by use of additional claim transformation modules or submodules that are guaranteed to run at the end of the other transformations, as shown and described as transformation check operations 522 and 618. An additional security feature is provided in the administrator's ability to control which claim(s) or claim set(s) each transformation module is allowed to manipulate, as shown and described with reference to evaluate operation 606 and parsing criteria 628, 630 and 632, for example. A further security feature is associated with an embodiment of the present disclosure as shown in FIGS. 7 and 8, wherein the resultant claim set is isolated from each of the transformation modules or submodules so that each transformation module or submodule works only in the context of the original claim or claim set. The system then maintains and aggregates the resultant claims. Such a system is beneficial in its ability to provide security by retaining control of the final claim or claim set.

Having described the embodiments of the present disclosure with reference to the figures above, it should be appreciated that numerous modifications may be made to the present invention that will readily suggest themselves to those skilled in the art and which are encompassed in the scope and spirit of the invention disclosed and as defined in the appended claims. Indeed, while a presently preferred embodiment has been described for purposes of this disclosure, various changes and modifications may be made which are well within the scope of the present invention.

Similarly, although this disclosure has used language specific to structural features, methodological acts, and computer-readable media containing such acts, it is to be understood that the present invention defined in the appended claims is not necessarily limited to the specific structure, acts, or media described herein. For example, while this disclosure has referred to a resource provider as a trust partner in a trust relationship, any type of partner could benefit from this invention. By way of example only, a resource provider may be referred to as a service provider or a relying party. One skilled in the art will recognize other embodiments or improvements that are within the scope and spirit of the present invention. Therefore, the specific structure, acts, or media are disclosed as exemplary embodiments of implementing the claimed invention. The invention is defined by the appended claims.

What is claimed is:

1. A claim transformation system for transforming a claim from one format to a different format, the system comprising:
a first claim transformation submodule;
a second claim transformation submodule; and
wherein the first and second claim transformation submodules have the ability to transform a claim from one format to a plurality of different formats.

2. The claim transformation system defined in claim 1, wherein the first and second claim transformation submodules are arranged in a pipelined fashion.

3. The claim transformation system defined in claim 2, wherein the first and second claim transformation submodules are arranged to transform the claim until no change to the claim is detected.

4. The claim transformation system defined in claim 3, wherein the system further comprises a claim transformation submodule to verify whether any changes made by the other submodules are unallowable.

5. The claim transformation system defined in claim 2, wherein:
the first claim transformation submodule transforms the claim in its original format to produce a first resultant claim;
the second claim transformation submodule processes the claim in its original format to produce a second resultant claim; and
an aggregation module aggregates the first and second resultant claims to produce a final claim.

6. The claim transformation system defined in claim 1, wherein:
the system directs the claim to the first claim transformation submodule if that submodule is determined to be proper for that processing; and
the system directs the claim to the second claim transformation submodule if that submodule is determined to be proper for that processing.

7. The claim transformation system defined in claim 6, wherein the first and second claim transformation submodules transform the claim until no change is detected.

8. The claim transformation system defined in claim 7, wherein the system further comprises a claim transformation submodule to verify whether any changes made by the other submodules are unallowable.

9. The claim transformation system defined in claim 6, wherein:
the first claim transformation submodule transforms the claim in its original format to produce a first resultant claim;
the second claim transformation submodule transforms the claim in its original format to produce a second resultant claim; and
an aggregation module aggregates the resultant claims to produce a final claim.

10. A method for transforming a claim at an extensibility point in a trust relationship environment, the method comprising:
maintaining in a trust relationship environment an extensibility point, wherein a single claim transformation submodule or multiple claim transformation submodules may be plugged in;
determining the first format of the claim;
determining the second format of the claim;
creating a claim transformation submodule customized to change the claim format from the first format to the second format; and
plugging the claim transformation submodule into the extensibility point.

11. The method as defined in claim 10, wherein the method further comprises configuring the submodules into a pipeline as part of the extensibility point.

12. The method as defined in claim 11, wherein the method further comprises plugging in an additional submodule.

13. The method as defined in claim 10, wherein the method further comprises determining the proper claim transformation submodule to which to send the claim.

14. The method as defined in claim 10, wherein the method further comprises processing the claim until steady state is achieved.

15. The method as defined in claim 10, wherein a claim set is involved and wherein the transforming applies to all claims within the claim set.

16. The method as defined in claim 10, further comprising:
sending the claim in its original format to a claim transformation submodule to transform the claim into a resultant claim;
separating the resultant claim from a claim transformation submodule from the resultant claims from other claim transformation submodules;
gathering the resultant claims;
aggregating the resultant claims to produce a final claim.

17. An extensible system for sharing and transforming claim information in a trust relationship, the system comprising:
a resource provider requesting information to authenticate an account;
an identity provider providing authentication information to the resource provider;
an account store maintaining authentication information to populate a claim to send to the requesting resource provider; and
an extensibility point, wherein one or more claim transformation submodules may be plugged in as part of such point to transform the claim from a first format provided by the identity provider to a second format recognized by the resource provider.

18. The extensible system as defined in claim 17, wherein the claim transformation submodules are arranged in a pipelined fashion.

19. The extensible system as defined in claim 17, wherein the claim is sent only to the claim transformation submodules deemed proper for processing the claim.

20. The extensible system as defined in claim 17, wherein an additional extensibility point exists to transform the format of a claim received from an identity provider to a format recognized by a resource application.
